(19) United States
(12) Patent Application Publication
(10) Pub. No.: US 2009/0206312 A1
(43) Pub. Date: Aug. 20, 2009

(54) Safety rail guard system

(76) Inventor: Michael B. Franklin, Venice, FL (US)

Correspondence Address: Michael B. Franklin, 905 Riviera Street, Venice, FL, 34285, US

(21) Appl. No.: 12/070,046

(22) Filed: Feb. 15, 2008

(51) Int. Cl. E04H 17/00; F16B 35/00

(52) U.S. Cl. 256/65.09; 411/372.5; 256/59

(57) ABSTRACT

A guard rail system includes upstanding and profiled stanchions that have lateral openings therein. The lateral openings receive horizontal rails therein the ends of which are adjacent to each other. The horizontal stanchions have fasteners on one side thereof, that when activated will pressure-fit the two adjacent rails within the opening. The openings are so designed that any two adjacent rails placed therein can be placed therein at a slant if the guard rail system is installed on a stairway. The stanchions and the rails are manufactured from a fiberglass composition that renders the various elements extremely durable. In an alternative embodiment, individual brackets can be mounted in each side of a window opening in a wall without the use of the stanchions. A horizontal rail is placed in each of the brackets and pressure fitted against the wall.

### BACKGROUND OF THE INVENTION

The present invention relates to a safety guard rail system. Safety guard rail systems are used anywhere were a temporary safety guard railing is required and, that is, in buildings under construction where no permanent barriers have been or could be provided because aspects of the construction of the building are not present at the time. The code requires that all openings, doors or windows, many floor margins or stairways must be provided with some kind of barrier to prevent the workers from falling off the buildings or through openings. While a building is under construction, a large floor openings is created throughout all the floors in the building, these openings are also called a chase. They will eventual provide for elevator shafts once the building is finished. These openings also must be provided with a barrier for obvious reasons. So far, these barriers are made of rough lumber pieces that are nailed or screwed together and in many instances cannot be used again because they have been cut to certain sizes, while in another location different dimensions are required and the previously cut dimensions will not fit at that new location.

### BRIEF DESCRIPTION OF THE INVENTION

The inventive concept provides for a multiple of preformed and profiled stanchions that are made of fiberglass composite material that will never rust or needs to be repainted for aesthetic reasons or for appearance. The stanchions have lateral openings therein to receive rails therein which are also made of fiberglass compositions. The stanchions have bottom plates thereon that can be fastened to a concrete surface with lag screws, for example, or with clamps where feasible. The stanchions also have fastening elements in each of their openings so that any rails placed in any of the openings may be fastened therein. At the location of the fastening elements there are provided shrouds to protect the heads of the fastening elements from being damaged while the construction in the building progresses.

It is also envisioned that individual brackets on walls can be provided at openings where stanchions cannot be used. The brackets have a certain profile to accept the rails and the fastening of the rails will be the same as was shown on the stanchions.

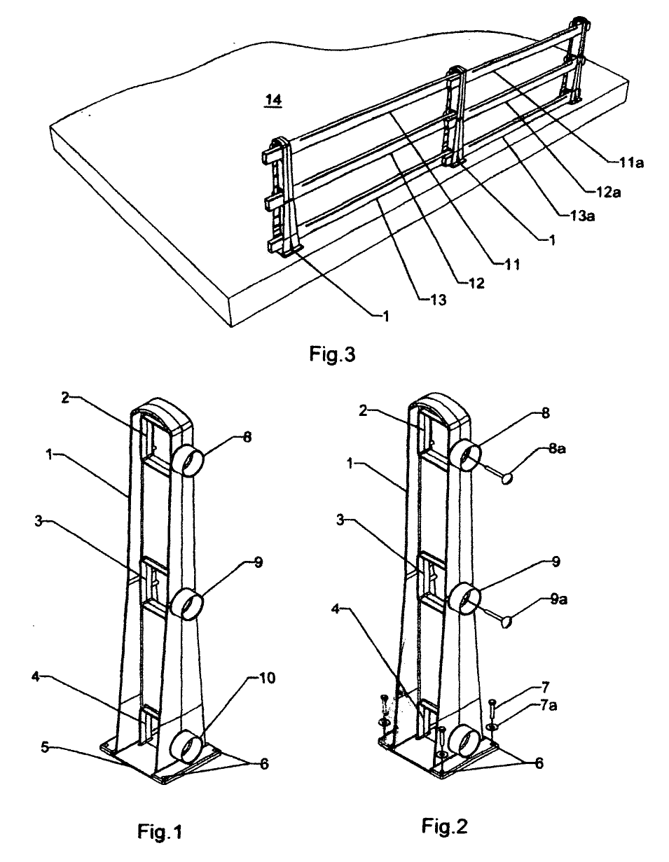

FIG. 1 shows an upright stanchion or post FIG. 2 shows the stanchion of FIG. 1 including a showing of the fastening elements;

FIG. 3 illustrates an installation on a horizontal surface;

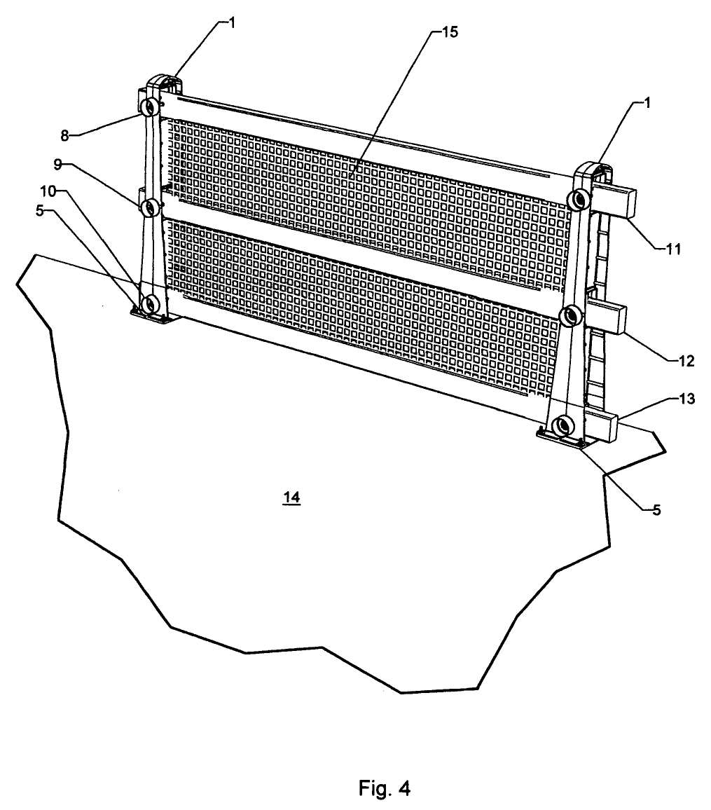

FIG. 4 shows the installation of FIG. 3 with a safety net provided;

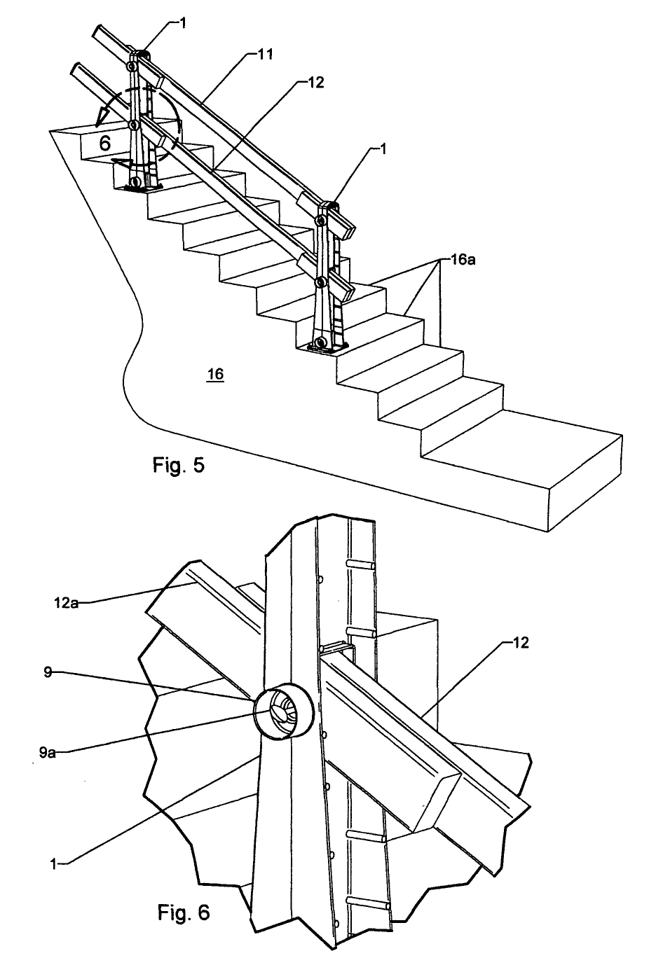

FIG. 5 shows the inventive barrier installed on a stairway;

FIG. 6 illustrates details of the installation of FIG. 5;

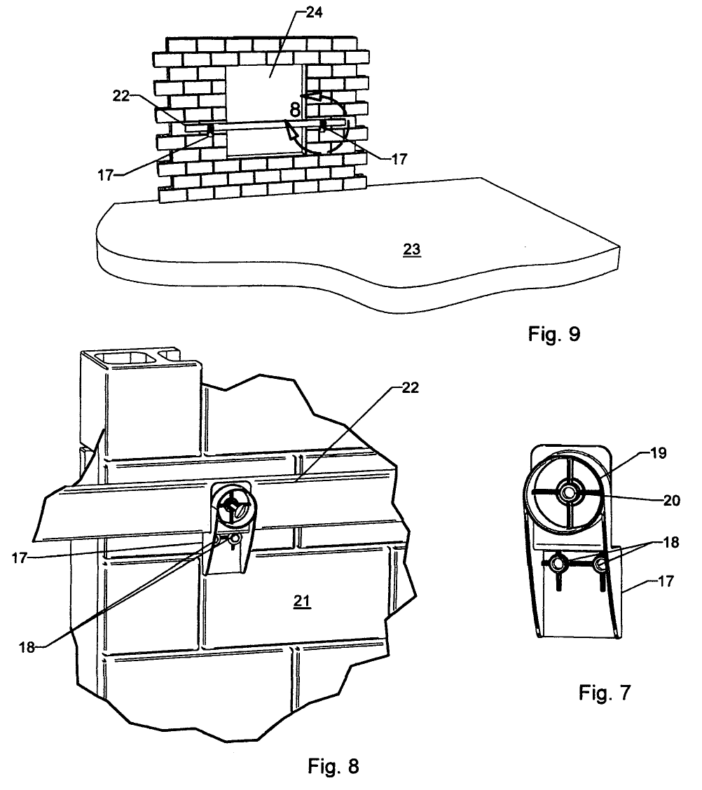

FIG. 7 illustrates a bracket to be used on a wall;

FIG. 8 shows the bracket of FIG. 7 installed in a wall opening;

FIG. 9 illustrates details of the installation of FIG. 8.

### DETAILED DESCRIPTION OF THE INVENTION

FIG. 1 illustrates an upstanding stanchion 1 or a post that will be used to install horizontal barriers on floors while a building is under construction. The stanchion 1 is profiled to give it added rigidity and strength. The stanchion will be constructed of a fiberglass composition material which adds to its long life and aids repeated uses. The stanchion 1 has at least 3 lateral openings, there is an upper opening, a middle opening 3 and a lower opening 4. The stanchion 1 also has a bottom plate 5 which is useful to be fastened to a concrete surface through fastening holes 6. A side of the stanchion 1 has upper, middle and lower shrouds 8, 9, and 10, respectively. These shrouds are designed and placed at theses particular locations as protective devices to protect the heads of fasteners that are placed through the stanchion 1 against rails within the openings 2, 3, and 4, as will be explained below.

FIG. 2 shows the same stanchion of FIG. 1 except the FIG. 2 shows the details of the fasteners. The bottom plate 5 may fastened through the holes 6 to a concrete surface by way of fasteners 7 including washers 7a. The fasteners may be lag screws. Clamps could also be used at the edge of a concrete slab by spanning the slab with a clamp and onto the bottom plate 5. A side of the stanchion 1 again shows the protective shrouds 8. 9 and 10 and the fasteners 8a, 9a and 10a will pass through the stanchion to fasten or tighten any rails placed therein by pressure against each other.

FIG. 3 illustrates an assembled barrier consisting of the stanchions 1 separated a predetermined distance from each other to form a first section. The stanchions 1 are fastened to the concrete slab 14 by lag screws as was explained with reference to FIG. 2. The horizontal rails 11, 12 and 13 are placed respectively, within the upper, middle and lower openings of the stanchion. A second section is likewise established between adjacent stanchions 1 and again the rails 11a, 12a and 13a are placed, respectively, within the upper openings 2, 3 and 4 to form a second barrier section. The advantage of this arrangement is that the openings 2, 3 and 3 in the stanchions are wide enough to accommodate two rails next to each other, whereby two neighboring rails can be fastened with only one of the fasteners in each respective lateral opening by way of pressure.

FIG. 4 shows an assembled barrier section as was explained above with reference to FIGS. 1-3. This arrangement includes a safety netting 15 which spans the distance between the stanchions and the horizontal rails. This safety netting 15 provides additional safety for objects and/or trash that could fall multiple stories to the ground.

FIG. 5 shows a barrier arrangement that is applied to a staircase 16 including the steps 16a. Shown is only a section of the railings 11 and 12 between the stanchions 1. Each of the stanchions 1 is fastened to their respective steps 16a by fasteners (not shown in this Fig.). The advantage of the profile and the structure of the stanchions is that the rails 11 and 12 can be placed within the openings in the stanchions in a slanted manner instead of in a horizontal manner as was shown in FIGS. 3 and 4.

FIG. 6 Shows the details of the stairway barrier of FIG. 5. The stanchion 1 shows two adjacent or side by side rails 12 and 12a. As can be seen in this FIG. 6, the middle opening in the stanchion 1 is large enough to accommodate two rails side by side and at a slant because of the upward positioning on a stairway. Yet, this arrangement will still be a rigid structure, because of the clamping fasteners 9a that passes through the side of the stanchion and places pressure on the side by side rails.

FIG. 7 illustrates a bracket 17 that may be used when a stanchion cannot be used because of an opening in the wall. The bracket 17 has an offset that, when the clamp is fastened to a wall, will leave enough spacing to accommodate a rail. The bracket 17 has two holes 18 which will be used to fasten the bracket to a wall by using appropriate fasteners. The bracket 17 also has the same shroud 19 as was discussed in previous Figs. To reiterate, the shroud 19 is provided to protect the head of a fastener passing though the hole 20 that is used to fasten a rail against the wall.

FIG. 9 shows a window opening 24 in a wall 21 which is protected by a rail 22 which is fastened to the wall 21 by the brackets 17.

It can now be seen that a very versatile safety barrier has been provided which can be used over and over again in many different installations. The material is durable because it is made of fiberglass composition and can be painted many different colors. The colors can be determined during the extrusion or molding process. The brackets can be made of steel.

The rails can have dimensions of a 2×4 cross-section and any lengths that are dictated by the building under construction. The safety rails of two each in a horizontal or stairway installation can be at least 10′ between the upstanding stanchions. The strengths of the various materials exceed any codes proscribed by OSHA. Any of the installed elements will not rust and never need painting. The suggested color for the stanchions is a bright yellow and orange in color for the rails. This adds to the safety features of the overall barrier because these colors easily catch a person's eye.

What I claim is:

1. A guard rail system including upstanding and profiled stanchions having at least three lateral openings therein, said lateral openings are adapted to receive horizontal rails therein to be supported by two adjacent stanchions, means on said stanchions to fasten at least two adjacent rails within said openings, said stanchions and said rails are manufactured from a fiberglass composition.

2. The guard rail system of claim 1 including a base plate on a bottom of each of said stanchions, said base plates having holes s therein to receive fasteners there through, said fasteners fasten each of said stanchions to a surface below.

3. The guard rail system of claim 1, wherein said means to fasten on said stanchions include a screw fastener passing through one side of said lateral openings only, whereby a pressure fit is obtained between adjacent rails in said openings.

4. The guard rail system of claim 3, wherein shrouds are provided to protect heads of said screw fasteners from damage.

5. The guard rail system of claim 1, wherein each of said lateral openings can accommodate ate least two adjacent rails in a slanted manner when said guard rail system is installed on a stairway.

6. A guard rail system including individual brackets having means thereon to be fastened to a wall having a window opening therein, a bracket is fastened to said wall at each side of said window opening, A horizontal guard rail is installed at each end in each of said brackets, means on said brackets for pressure fitting said rail against said wall, said brackets are made of steel while said rail is made of a fiberglass composition.

7. The guard rail system of claim 6 wherein said means for pressure fitting said rail against said wall is a screw element having a head thereon.

8. The guard rail system of claim 7, including a shroud on an outside of said bracket to protect said head from damage.
